(19) United States
(12) Patent Application Publication
(10) Pub. No.: US 2023/0362752 A1
(43) Pub. Date: Nov. 9, 2023

(54) EFFICIENT BEAM SWEEPING WHEN SERVING UNMANNED AERIAL VEHICLES OVER ADVANCED NETWORKING EQUIPMENT

(71) Applicant: AT&T Technical Services Company, Inc., Vienna, VA (US)

(72) Inventor: Daniel Vivanco, Ashburn, VA (US)

(21) Appl. No.: 17/661,807

(22) Filed: May 3, 2022

(51) Int. Cl. H04W 36/00; H04W 16/28; H04W 52/02

(52) U.S. Cl. CPC H04W 36/0072; H04W 16/28; H04W 52/0206; H04W 84/005

(57) ABSTRACT

An architecture to provide efficient beam sweeping when servicing unmanned aerial vehicles over advanced network equipment. A method can comprise determining that a user equipment is an unmanned aerial vehicle, instructing serving cell equipment to power up a first group of beams, instructing neighbor serving cell equipment to power a second group of beams, based on tracking data and the first group of beams to which the unmanned aerial user equipment is attached, determining a trajectory associated with a flight path of the unmanned aerial vehicle, based on the trajectory, the flight path, and a handover event, determining that the neighbor cell equipment is servicing the unmanned aerial vehicle, and instructing the serving cell equipment to power down the first beam of the first group of beams to allow energy conservation, reduction, and/or preservation at the serving cell equipment.

### TECHNICAL FIELD

The disclosed subject matter relates to efficient beam sweeping when servicing aerial user equipment (UE) or unmanned aerial vehicles (UAVs) over advanced network equipment, such as, but not limited to long term evolution (LTE) and/or fifth-generation (5G) network equipment.

### BACKGROUND

Wireless operators can use terrestrial cellular network equipment, such as long-term evolution (LTE) and/or fifth-generation (5G) core mobile network operator (MNO) equipment to provide services to aerial UE. Aerial user equipment UE can have multiple use cases (e.g., delivery, monitoring, . . . ). Wireless operators can have aerial coverage maps, which can indicate areas with and without cellular coverage. In addition, unmanned aerial vehicles (UAVs), such as aerial UE, can scan neighbor equipment signal pilots (e.g., reference signal received power (RSRP) measurement values) to determine whether they can fly in a given direction.

### BRIEF DESCRIPTION OF DRAWINGS

FIG. 1 is an illustration of a system for efficient beam sweeping when servicing aerial UE or UAVs over advanced network equipment, in accordance with aspects of the subject disclosure.

FIG. 2 provides illustration of a flow chart, time sequence chart, or method for efficient beam sweeping when servicing aerial UE or UAVs over advanced network equipment, in accordance with aspects of the subject disclosure.

FIG. 3 provides illustration of a flow chart, time sequence chart, or method for efficient beam sweeping when servicing aerial UE or UAVs over advanced network equipment, in accordance with aspects of the subject disclosure.

FIG. 4 provides illustration of a flow chart, time sequence chart, or method for efficient beam sweeping when servicing aerial UE or UAVs over advanced network equipment, in accordance with aspects of the subject disclosure.

FIG. 5 provides illustration of a flow chart, time sequence chart, or method for efficient beam sweeping when servicing aerial UE or UAVs over advanced network equipment, in accordance with aspects of the subject disclosure.

FIG. 6 provides depiction of a flow chart, time sequence chart, or method for efficient beam sweeping when servicing aerial UE or UAVs over advanced network equipment, in accordance with aspects of the subject disclosure.

FIG. 7 depicts a flow chart, time sequence chart, or method for efficient beam sweeping when servicing aerial UE or UAVs over advanced network equipment, in accordance with aspects of the subject disclosure.

FIG. 8 depicts example SSB groups, example SSB burst periods, and SSB beam sweeping, in accordance with aspects of the subject disclosure.

FIG. 9 depicts a scenario where disparate emitted beams are servicing aerial UE and terrestrial based UE.

FIG. 10 provides depiction of network equipment association patterns at different altitudes, in accordance with aspects of the subject disclosure.

FIG. 11 is a block diagram of an example embodiment of a mobile network platform to implement and exploit various features or aspects of the subject disclosure.

FIG. 12 illustrates a block diagram of a computing system operable to execute the disclosed example embodiments.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

The disclosed subject matter, in accordance with various embodiments, provides a system, apparatus, equipment, or device comprising: a processor (and/or one or more additional processors), and a memory (and/or one or more additional memories) that stores executable instructions that, when executed by the processor, facilitate performance of operations. The operations can comprise based on user equipment data and tracking data associated with user equipment, determining that a user equipment is an unmanned aerial vehicle, instructing serving cell equipment to power up a first beam of a first group of beams, instructing neighbor serving cell equipment to power a second beam of a second group of beams, determining, based on the tracking data and the first beam to which the unmanned aerial user equipment is attached, a trajectory of trajectories associated with a flight path of the unmanned aerial vehicle, based on the trajectory, the flight path, and hand over event data representing a handover of the unmanned aerial vehicle from the serving cell to the neighbor serving cell, determining that the neighbor cell equipment is servicing the unmanned aerial vehicle, and instructing the serving cell equipment to power down the first beam of the first group of beams.

Additional operations can comprise determining the first group of beams based on a group of antenna arrays that are pointing upward and/or are substantially pointing upward, determining the second group of beams based on a group of antenna arrays that are pointing upward, monitoring the unmanned aerial vehicle through a broadcast coverage area projected by the serving cell equipment based on determining a time or arrival of an energy wave having a defined waveform propagated among the serving cell equipment, tracking the unmanned aerial vehicle through a broadcast coverage area projected by the serving cell equipment based on determining a time or arrival of an energy wave having a defined velocity propagated among the serving cell equipment, and determining the trajectory of trajectories based on a multi-objective optimization representing a determination that a group of first actions is to be implemented in response to a group of second actions, on a balance of probabilities, are not detrimentally affected.

In regard to the foregoing the user equipment data can comprise flag data that represents that the unmanned aerial vehicle is capable of flight, and the tracking data can comprise global navigation satellite system data representing a coordinate pairing representing a geographical position of the unmanned aerial vehicle.

Additionally and/or alternatively in the context of the foregoing the first beam of the first group of beams corresponding to the serving cell equipment can be powered down based on an absence of the unmanned aerial vehicle to preserve energy, and the first beam of the first group of beams can be powered up based on detecting that the unmanned aerial vehicle has entered, or is entering, a coverage region of the serving cell equipment, wherein the first group of beams are powered up to enable communication between the serving cell equipment and the unmanned aerial vehicle. Also, the second beam of the second group of beams corresponding to the neighboring serving cell equipment can be powered down based on an absence of the unmanned aerial vehicle to preserve energy, and the second beam of the second group of beams can be powered up based on detecting that the unmanned aerial vehicle has entered, or is entering, a coverage region of the neighboring serving cell equipment, wherein the second group of beams are powered up to enable communication between the neighboring serving cell equipment and the unmanned aerial vehicle.

In accordance with further embodiments, the subject disclosure describes methods and/or processes, comprising a series of acts that, for example, can include: based on user equipment data and tracking data associated with user equipment, determining, by a device comprising a processor, that a user equipment is an unmanned aerial vehicle, instructing, by the device, serving cell equipment to power up a first beam of a first group of beams, instructing, by the device, neighbor serving cell equipment to power a second beam of a second group of beams, based on the tracking data and the first beam to which the unmanned aerial user equipment is attached, determining, by the device, a trajectory of trajectories associated with a flight path of the unmanned aerial vehicle, based on the trajectory, the flight path, and hand over event data representing a handover of the unmanned aerial vehicle from the serving cell to the neighbor serving cell, determining, by the device, that the neighbor cell equipment is servicing the unmanned aerial vehicle, and instructing, by the device, the serving cell equipment to power down the first beam of the first group of beams.

Further act can include determining, by the device, the first group of beams based on a group of antenna arrays that are pointing upward, determining, by the device, the second group of beams based on a group of antenna arrays that are pointing upward, monitoring, by the device, the unmanned aerial vehicle through a broadcast coverage area projected by the serving cell equipment based on determining a time or arrival of an energy wave having a defined waveform propagated among the serving cell equipment, tracking, by the device, the unmanned aerial vehicle through a broadcast coverage area projected by the serving cell equipment based on determining a time or arrival of an energy wave having a defined velocity propagated among the serving cell equipment, and determining, by the device, the trajectory of trajectories based on determining that a group of first actions is to be implemented in response to a group of second actions, on a balance of probabilities, are not detrimentally affected.

In accordance with still further embodiments, the subject disclosure describes machine readable media, a computer readable storage devices, or non-transitory machine readable media comprising instructions that, in response to execution, cause a computing system (e.g., apparatus, equipment, devices, groupings of devices, etc.) comprising at least one processor to perform operations. The operations can include: based on user equipment data and tracking data associated with user equipment, determining that a user equipment is an unmanned aerial vehicle, instructing serving cell equipment to power up a first beam of a first group of beams, instructing neighbor serving cell equipment to power a second beam of a second group of beams, based on the tracking data and the first beam to which the unmanned aerial user equipment is attached, determining a trajectory of trajectories associated with a flight path of the unmanned aerial vehicle, based on the trajectory, the flight path, and hand over event data representing a handover of the unmanned aerial vehicle from the serving cell to the neighbor serving cell, determining that the neighbor cell equipment is servicing the unmanned aerial vehicle, and instructing the serving cell equipment to power down the first beam of the first group of beams.

Other operations can include monitoring the unmanned aerial vehicle through a broadcast coverage area projected by the serving cell equipment based on determining a time or arrival of an energy wave having a defined waveform propagated among the serving cell equipment, tracking the unmanned aerial vehicle through a broadcast coverage area projected by the serving cell equipment based on determining a time or arrival of an energy wave having a defined velocity propagated among the serving cell equipment, and determining the trajectory of trajectories based on determining that a group of first actions is to be implemented in response to a group of second actions, on a balance of probabilities, are not detrimentally affected.

The subject disclosure, in general, describes advanced network (e.g., NR 5G) beam sweeping. In general, in advanced network beam sweeping, UE can perform cell searches on groups of permitted/allowed frequencies. The synchronization raster indicates the frequency positions of the synchronization blocks that can be used by UE for system acquisition. The channel raster defines step-sizes for this search procedure and consequently it can influence the time UE will take to complete initial search procedures. In further steps, UE can decode primary synchronization signals (PSS) data, secondary synchronization signals (SSS) data, and the new radio physical broadcast channel (NR-PBCH) data which can be transmitted as synchronization signal block (SSB) data. SSB data can comprise four-symbols, one-symbol PSS data, one-symbol SSS data, and two-symbol physical broadcast channel (PBCH) data. Time synchronization in terms of symbol-level and slot-level and frequency synchronization can be realized via PSS data and/or SSS data.

In advanced networks, UE typically need to decode PSS data and SSS data to gain knowledge of physical cell identifier (PCI) data, and then UE can be in a position to decode PBCH data, where UE can receive master information block (MIB) data. Once UE decodes the PBCH data, the UE can decode physical downlink control channel (PDCCH) data and physical downlink shared channel (PDSCH) data to obtain any remaining minimum system information (RMSI) data and other system information (OSI).

In advanced networks, beam sweeping refers to a technique in which serving cell equipment transmit energy beams in predefined directions in a burst at regular intervals (e.g., defined intervals), which may cover the entire broadcast serving cell coverage area. SSB data can be transmitted in a batch by forming a synchronization signal burst (SSB)—comprising one SSB per beam—that can be used during beam sweeping by changing beam direction for each SSB transmission. Beam sweeping can be used by UE to measure and identify the best beam for the particular UE. A collection of SSBs can be referred to as a SSB group. Both SSBs and SSB groups can contain one or more elements, wherein the maximum number of SSBs in a SSB group can be frequency-dependent and generally it can comprise: four frequency bands below 3 gigahertz Hertz (GHz); eight frequency bands between 3 to 6 GHz; or 64 frequency bands between 6 to 52.6 GHz. The periodicity of the SSB can be configured by core network equipment, while the default transmission periodicity for initial serving cell equipment selection, and the SSB group periodicity can be the default at 20 milliseconds (ms) for all frequency ranges (e.g., 2 NR frames). The frame and slot time is can be defined by the identifiers of SSBs and acquired by the UE.

SSBs can be transmitted as a burst in the downlink (DL) direction to the UE. Transmit/receive point (TRP) and UE beam sweeping can be used to establish a beam-pair link. Once the connection is established, the same beam-pair link can generally be applied to subsequent transmissions. The reference signal receive power (RSRP) can be measured (determined) for each of the transmit-receive beam pairs, and the beam-pair link with the maximum RSRP can be used.

Serving cell equipment can define multiple candidate positions for SSBs within a radio frame, this number can correspond to the number of beams radiated in a defined or determined direction. Each SSB can be identified by a unique number called a SSB index. An identification of which SSB is detected can depend on where UE is located within the coverage ambit of the radiated beams. UE can measure (determine) the signal strength of each SSB that it detects for a certain defined time period (e.g., a time period measured by the time that elapses for the emission of about one SSB grouping). From this measurement result, UE can identify the SSB index with the strongest signal strength. This SSB with the strongest signal strength can typically be the best beam to which the UE should attach.

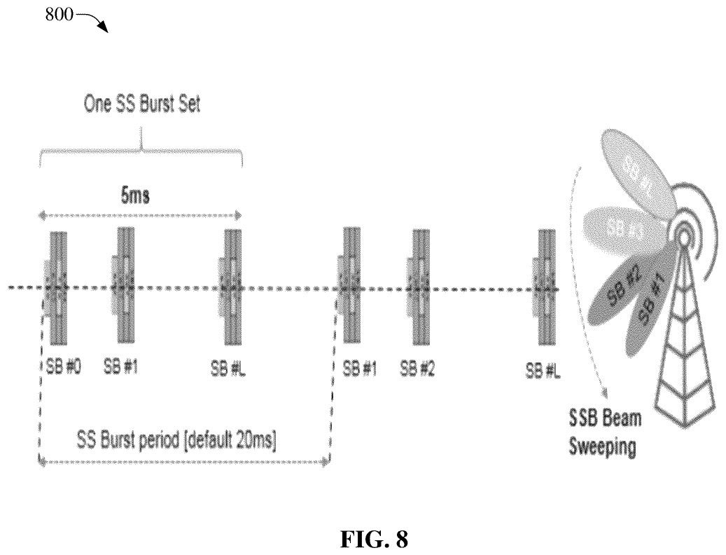

UE, thus selects the “best beam” amongst the beam grouping(s) and sends physical random access channel (PRACH) data to the location which can have been mapped to a specific SSB beam identifier (ID). The serving cell equipment that emitted the best beam grouping(s) can then determine which beam of the radiated beam groupings that UE detected based on the PRACH data it receives from the UE. In regard to the foregoing detail with respect to example SSB groups (e.g., SSB set), example SSB burst periods, SSB beam sweeping, reference can be made to FIG. 8.

Fifth generation (5G) new radio (NR) network equipment can transmit several beams in disparate but predefined directions, most of these beams typically will be pointing down towards terrestrial based UE devices. However, mobile network operator entities (MNOs) can configure some of the beams being emitted from network equipment (e.g., serving cell equipment) to point out towards UAVs (aerial UE devices). Typically, UAVs can connect sporadically to the network infrastructure. Therefore, beams pointing upwards or substantially pointing upward may only be used infrequently within defined periods of time in comparison with terrestrial based UEs. Network equipment, such as serving cell equipment, base station equipment, gNB equipment, eNB equipment, eNodeB equipment, eNodeB equipment, and the like now have the capability of being able to enable and/or disable sector beams to preserve energy and reduce interference. However, the current third (3^{rd}) generation partnership project (3GPP) standards currently do not provide procedures to enable/disable sector beams configured to serve UAVs based on the presence of aerial UEs being detected within the broadcast ambit (e.g., control and/or broadcast coverage area) of serving cell equipment.

The subject disclosure provides systems and methods for efficient beam sweeping when serving UAVs over advanced networks. The disclosed systems and/or methods can be placed at a central node global control equipment on the core network. For example, one or more of the processes disclosed herein can be executed on mobile edge computing (MEC) equipment, self organized network (SON) equipment, or radio access network (RAN) intelligent controller (RIC) equipment. In various embodiments, the executed processes identify UAVs based on international mobile subscriber identifier (IMSI) values, or subscriber identity module or subscriber identification module (SIM) data values (e.g., one or more integrated circuits that can securely store subscriber identification values and related key values and that can be used to identify and authenticate subscriber UE). In response to receiving or obtaining IMSI values and/or SIM data values, the executing processes can direct serving cell equipment to power up and/or power down one or more identified and/or selected beams that have been configured to be upward pointing. By directing serving cell equipment to selectively power up and/or power down one or more selected and determined upward pointing beams the energy used by these beams can be better managed based on the location and actual presence of the UAVs within the broadcast coverage area of serving cell equipment, and within the entirety of the core network infrastructure. Additionally, implementation of the disclosure set forth herein can minimize connection delays and dropped calls between UAVs and serving cell equipment when connecting to terrestrial advanced network infrastructures.

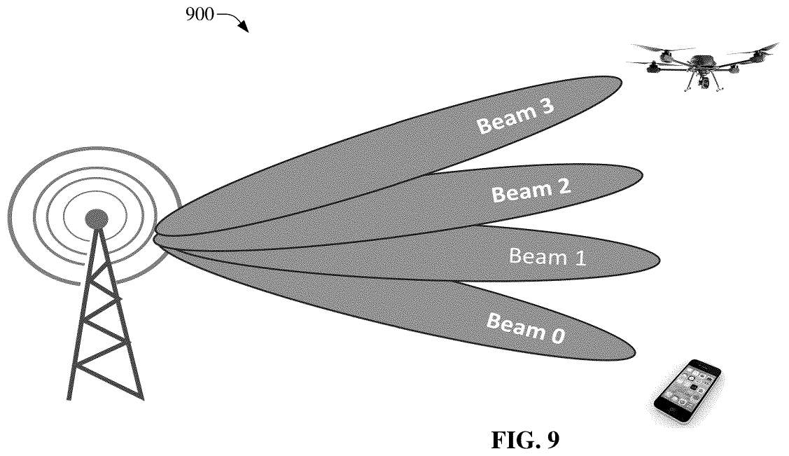

As noted above, 5G NR equipment can transmit several beams in disparate but predefined directions, generally most of these beams typically will be pointing down towards terrestrial based UE and/or servicing these terrestrial based UE. Nevertheless, MNOs can in many instances configure some of the beams to be upward facing directed to UAVs. In FIG. 9 it will be observed that terrestrial UE can be served by Beam 0, while UAVs can be serviced by Beam 3.

Generally, it can be expected that UAVs will connect to serving cell equipment sporadically. Thus, beams pointing upwards (e.g., beams associated with up tilted antennae or substantially upward facing antennae), for instance, Beam 3, may only be used infrequently by UE and/or aerial UE.

5G NR serving cell equipment typically have the capability to enable and/or disable sector beams to preserve energy and reduce interference. Nevertheless, as observed above, current 3GPP standards generally do not provide procedures to on demand enable/disable sector beams configured to serve UAVs based on their presence within the control and/or serving broadcast range cast by 5G NR serving cell equipment.

Wireless mobile network operator entities (MNOs) can use terrestrial based cellular network equipment, such as long-term evolution (LTE) and/or fifth-generation (5G) core mobile network operator (MNO) equipment (e.g., serving cell equipment, base station equipment, access point equipment, internet of things (IoT) equipment, picocell equipment, femtocell equipment, and/or other similar and pertinent equipment) to provide services to aerial UE. Aerial UE can have multiple use cases (e.g., delivery, monitoring, . . . ). Wireless MNOs can have aerial coverage maps, which can indicate areas with and/or without cellular coverage. In addition, UAVs, such as aerial UE, can scan neighbor equipment signal pilots (e.g., reference signal received power (RSRP) measurement values) to determine whether it can fly in a given direction. In instances where signal pilots are not detectable in a direction in which an UAV is traversing, the UAV can change or adjust its trajectory to better align with cellular coverage where appropriate signal pilots are more evident.

The subject disclosure provides for detecting and/or identifying UE based, for example, on international mobile subscriber identifier (IMSI) values, or subscriber identity module or subscriber identification module (SIM) values (e.g., one or more integrated circuits that can securely store subscriber identification values and related key values and that can be used to identify and authenticate subscriber UE).

In various embodiments, approaching UE can be identified based on other subscriber or subscription data, such as unique UE serial number values, governmentally issued unique identification values (e.g., federal aviation administration tag values), UE manufacturer serial number values, unique visual identification values affixed to UE, unique identification values rendered perceivable using, for example, irradiated ultra-violet light, and/or unique identification values rendered observable, for instance, through illumination using infra-red light.

In other embodiments, identification of approaching UE can be facilitated using one-dimensional and/or multi-dimensional scanning technologies and barcode symbology, such as universal product codes (UPCs), matrix bar codes (e.g., quick response (QR) codes) comprising machine-readable optical labels, and the like that can include information about the equipment to which it is attached.

In one or more embodiments, having identified and/or detected an approaching UE, the detected UE can be monitored and tracked to determine whether or not the approaching UE is on a trajectory that may cause the approaching UE to enter into the control and service scope of core network equipment, such as central node global control equipment. In order to determine whether or not the approaching UE may be on a trajectory that may bring it within control and service ambit of core network equipment, artificial intelligence technologies, neural networking architectures, collaborative filtering processes, machine learning techniques, and/or big data mining functionalities can be utilized, wherein, for example, probabilistic determinations based at least in part on cost benefit analyses (e.g., the cost of taking a particular action is weighed against the benefit of taking the particular action, wherein in response to determining that the benefit associated with the action more likely than not outweighs the cost associated with the action, the action is identified as an action worthy of consideration and implementation) can be undertaken. In additional and/or alternative other embodiments, artificial intelligence technologies, neural networking architectures, collaborative filtering processes, machine learning techniques, Bayesian belief systems, big data mining and data analytic functionalities, and the like, can be employed, wherein, for example, multi-objective optimization (e.g., Pareto optimization) can be used to determine whether or not an action should be initiated and implemented. Multi-objective optimization can ensure that first actions or groups of first actions can only be implemented provided that other second actions or groups of other second actions are, on a balance of the probabilities, not detrimentally affected.

In example embodiments, in order to track UE entering and/or exiting the control and/or the monitoring ambit (e.g., processes in execution), one or more global navigation satellite system (GNSS) equipment can be used that can provide geolocation and/or time information to global positioning satellite (GPS) equipment (e.g., transmitter and/or receiver equipment) anywhere on or near the earth where there is an unobstructed line of sight to the one or more GNSS equipment, such as one or more GPS satellites in various earth orbits.

Additionally and/or alternatively, other triangulation processes can be used to keep track of UE. For instance, in various embodiments, ranges (e.g., variable distances) can be determined by targeting UE with light amplification by stimulated emission of radiation (e.g., laser) and measuring the time for the reflected light to return to one or more receiver (e.g., lidar) can be used to track UE approaching and/or entering into a determined vicinity of a transmission area cast by serving cell equipment. In a similar manner, a detection system that uses radio waves to determine the range, angle, or velocity of objects (e.g., radar) can be used to determine whether or not UE are approaching and/or entering into the determined vicinity of the monitoring scope of serving cell equipment.

Other mechanisms to track UE can also include using multilateration (e.g., determining UE position based on the measurement of the times of arrival (TOA) of one or more energy wave (e.g., radio, acoustic, seismic, etc.) having known waveforms and/or speed (velocity) when propagating either from and/or to multiple emitters and/or receivers of the waves) between one or more network equipment (e.g., serving cell equipment, base station equipment, internet of things (IoT) equipment, picocell equipment, femtocell equipment, and similarly functional equipment). In some instances, a UE's returned signal strength values to various antennae associated with the one or mode network equipment can be used to triangulate and provide a positional references as to the trajectory of an individual UE.

In additional and/or alternative instances, timing advance (TA) processes can be used as a measure of TOA. Typically, TA is a determined distance from serving cell equipment based at least in part on delay measurements associated with TOA values. TA values can be reported while aerial UE are in communication with serving cell equipment.

The described embodiments, provide for efficient beam sweeping when serving/servicing UAVs over advanced networks (e.g., 5G networks). In this regard, without limitation and/or loss of generality and for solely purposes of clarity of exposition, the following assumptions can be made: (a) in advanced network architectures serving cell equipment can have several beams configured, some groups pointing down and some groups pointing up; (b) UAVs will typically take off from the ground (or a surface—such as on a seagoing vessel), and as such UAVs will typically be served by beams that are pointing down; and (b) beams pointing up are initially powered down. In regard to the second assumption (e.g., “(b) UAVs will typically take off from the ground”), it should be appreciated, and it is within the contemplation of the applicant, that UAVs can be launched from the air (e.g., dropped, for instance, from aeronautical vehicles) and as such, in some embodiments, UAVs in these instances will typically be using beams emanating from up tilted antennae associated serving cell equipment.

The described embodiments, based on determining that UE are approaching defined or determinable areas controlled by serving cell equipment, core network equipment such as mobile edge compute (MEC) equipment, self organized network (SON) equipment, and/or radio access network (RAN) intelligent controller (RIC) equipment can initiate processes to facilitate and/or effectuate the following tasks: (1) based on report data that can have been received, for example, from the approaching UE, a determination can be made as to whether or not the approaching UE is a terrestrial based UE or an aerial UE (e.g. UAV). This determination can be made based, for instance, on IMSI values, SIM values, and/or a flag representative of whether or not the UE is an terrestrial based UE or an airborne vehicle (UAV) {e.g., UE.Type=0 or UE.Type=1, wherein “0” can be indicative of a terrestrial based UE, and “1” can be indicative of an UAV}; (2) in response to determining that the UE is actually an UAV, instruction can be directed to serving cell equipment (e.g., to which the UAV is attaching to, and/or to which the UAV is attached to, to power up first groups of beams that can be associated with a collection of up tilted antenna arrays that can be affiliated with the serving cell equipment; (3) also in response to determining that the UE is actually an UAV, additional instructions can be directed to neighboring serving cell equipment (e.g., to which control and/or service for the UAV, in the future, can be handed over (HO) to, to power up second groups of beams that can be associated with a aggregation of up tilted antenna arrays that can be affiliated with the neighboring serving cell equipment; (4) the UAV can be tracked, controlled, monitored, and/or serviced by the first groups of beams associated with the serving cell equipment, wherein tracking of the UAV can be facilitated by observation of a beam of the first groups of beams with which the UAV has attached to and has interactions with (e.g., the beam(s) of the first groups of beams that the serving cell equipment uses to control and/or service the UAV); (5) based at least in part on the beam and/or beam(s) of the first groups of beams with which the UAV has had, or is currently having, with the serving cell equipment, an inference can be made as one or more possible trajectory that the UAV can follow in a defined future time period (e.g., 5 nanoseconds, 10 microseconds, 10 seconds, 15 seconds, 45 seconds, 1 minute, 3 minutes, 5 minutes, . . . ), identification and/or determination of possible future trajectories that the UAV can take can be determined using artificial intelligence methodologies, cost benefit analyses, multi-objective optimization, neural network mechanisms, processes that implement fuzzy logic, and similar mechanisms; (6) based at least in part on the inference in regard to likely future trajectory that the UAV can take into a future projected time horizon (e.g., 5 nanoseconds, 10 microseconds, 10 seconds, 15 seconds, 45 seconds, 1 minute, 3 minutes, 5 minutes, . . . ), instruction can be sent to neighboring serving cell equipment, within the flight path(s) of the predicted and/or projected future trajectories associated with the UAV, that these neighboring serving cell equipment should power up their upward facing beam groupings; (7) based on tracking and/or monitoring the UAV, a determination can be made that the UAV is no longer associated with any of the beams that are being emitted by the serving cell equipment—responsibility for monitoring, tracking, controlling, and/or serving the UAV has been handed over to one or more neighboring serving cell equipment; and (8) in response to determining that the UAV has departed the control ambit of the serving cell equipment, instructions can be directed to the serving cell equipment that it should power down the first group beams, wherein the first group of beams are pointing up and are generally being emitted by collections of antenna arrays that are up tilted.

In the context of the subject disclosure, network equipment and/or serving cell equipment can typically be base station equipment, eNodeB equipment, eNB equipment, gNodeB equipment, picocell equipment, macrocell equipment, microcell equipment, femtocell equipment, IoT equipment operating as mobile network operation (MNO) network equipment, access point equipment, or other such equipment. Further, the disclosed systems and/or methods can be operational at central node global control equipment (e.g., network equipment) located in the core network. Examples of central node global control equipment can be mobile edge computing (MEC) equipment, self organized network (SON) equipment, and/or radio access network intelligent controller (RIC) equipment.

In some embodiments, UE information data and/or UE device type data is collected. It can be detected when, where, and whether an aerial UE is attached to, and/or is in operative communication with, the core network (or identifiable segments of the core network). Additionally, in accordance with further example embodiments, data can be collected that is representative of serving cell equipment capabilities, as well as network topologies of serving cell equipment (e.g., the network topologies of serving cell equipment currently providing service to aerial UE and/or terrestrial based UE situated within the broadcast range of current cell equipment and neighboring serving cell equipment that can be immediately proximate to, or positioned at distance from, current serving cell equipment). In accordance with various other example embodiments, data can also be collected that is representative of the geographical topographies and/or locations within which current serving cell equipment and its neighboring serving cell equipment are situated.

In accordance with some embodiments, based at least in part on data representative of UE information and UE device type, it can be determined whether or not a UE is an aerial UE. Information in regard to whether or not UE is an aerial type UE or terrestrial based UE can be conveyed and communicated to central node global control equipment as a flag comprising one or more bits. The central node global control equipment can then utilize and/or consult, for example, one or more database equipment comprising groups of relevant database tuples to correlate the received bits with an UE type (e.g., aerial UE or terrestrial based UE).

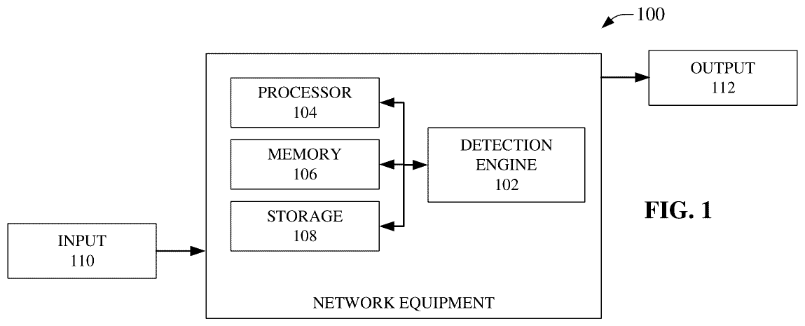

Now with reference to FIG. 1 that illustrates a system 100 (e.g., network equipment—central node global control equipment) that effectuates efficient beam sweeping when servicing aerial UE or UAVs over advanced network equipment, in accordance with various embodiments.

As illustrated system 100 can comprise detection engine 102 that can be communicatively coupled to processor 104, memory 106, and storage 108. Detection engine 102 can be in communication with processor 104 for facilitating operation of computer and/or machine executable instructions and/or components by detection engine 102, memory 106 for storing data and/or the computer or machine executable instructions and/or components, and storage 108 for providing longer term storage for data and/or machine and/or computer machining instructions. Additionally, system 100 can receive input 110 for use, manipulation, and/or transformation by detection engine 102 to produce one or more useful, concrete, and tangible result, and/or transform one or more articles to different states or things. Further, system 100 can also generate and output the useful, concrete, and tangible results, and/or the transformed one or more articles produced by detection engine 102, as output 112.

In some embodiments, system 100 can be Internet of Things (IoT) small form factor equipment capable of effective and/or operative communication with a network topology. Additionally in alternative embodiments, system 100 can be any type of mechanism, machine, device, apparatus, equipment, and/or instrument that can be utilized to dynamically configure inter-cell interference coordination between terrestrial based serving cell equipment that are serving aerial UE. Examples of types of mechanisms, equipment, machines, devices, apparatuses, and/instruments can include virtual reality (VR) devices, wearable devices, heads up display (HUD) devices, machine type communication devices, and/or wireless devices that communicate with radio network nodes in a cellular or mobile communication system. In various other embodiments, system 100 can comprise tablet computing devices, handheld devices, server class computing machines and/or databases, laptop computers, notebook computers, desktop computers, cell phones, smart phones, commercial and/or consumer appliances and/or instrumentation, industrial devices and/or components, personal digital assistants, multimedia Internet enabled phones, Internet enabled devices, multimedia players, aeronautical/avionic devices associated with, for example, orbiting satellites and/or associated aeronautical vehicles, and the like.

Detection engine 102 can identify UE, e.g., aerial UE and/or UAVs, based at least in part, for example, on IMSI values, or SIM values. Additionally and/or alternatively, detection engine 102 can identify approaching UE based on other subscriber or subscription data, such as unique UE serial number values, governmentally issued unique identification values, such as federal aviation administration tag values, UE manufacturer serial number values, UE model number values, unique visual identification values affixed to UE, unique identification values rendered perceivable using, for example, irradiated ultra-violet light, and/or unique identification values rendered observable, for instance, through illumination using infra-red light.

In other embodiments, identification of approaching UE can be facilitated by detection engine 102 through use of one-dimensional and/or multi-dimensional scanning technologies and barcode symbology, such as UPCs, matrix bar codes comprising machine-readable optical labels, and the like that can include information about the equipment to which it is attached.

In yet additional embodiments, identification of approaching UE can be effectuated detection engine 102 by using computer-vision based recognition technologies, wherein one or more unique surface contours (or identifiable surface point patterns) of the approaching UE can be compared with repositories and databases of manufacturer defined contours or determinable surface point patterns associated with UE.

Detection engine 102, having identified and/or detected approaching UE can monitor and track the detected UE to determine whether or not the approaching UE is on a trajectory that may bring it within the control scope of serving cell equipment. In order to determine whether or not the approaching UE may be on a trajectory that may may bring it within the control scope of serving cell equipment, detection engine 102, in some embodiments can utilize, for instance, artificial intelligence technologies, neural networking architectures, collaborative filtering processes, machine learning techniques, and/or big data mining functionalities, wherein, for example, probabilistic determinations based at least in part on cost benefit analyses can be performed.

In additional and/or alternative other embodiments, the detection engine 102 can employ artificial intelligence technologies, neural networking architectures, collaborative filtering processes, machine learning techniques, Bayesian belief systems, big data mining and data analytic functionalities, and the like, wherein, for example, multi-objective optimization can be used to determine whether or not an action should be initiated and implemented. Multi-objective optimization can ensure that first actions or groups of first actions can only be implemented provided that other second actions or groups of other second actions are not detrimentally affected.

Detection engine 102, in order to track UE entering and/or exiting the control and/or the monitoring ambit of equipment associated with network equipment 100, can also use one or more global navigation satellite system (GNSS) equipment (e.g., global positioning system (GPS) that can provide geolocation and/or time information to GNSS equipment anywhere on or near the earth where there is an unobstructed line of sight to the one or more GNSS equipment, such as one or more GNSS satellites in various earth orbits.

Additionally and/or alternatively, detection engine 102, in some embodiments, can use other triangulation processes to keep track of UE. For instance, in various embodiments, methods for determining ranges (e.g., variable distances) by targeting UE with light amplification by stimulated emission of radiation and measuring the time for the reflected light to return to one or more receiver can be used to track UE approaching and/or entering into a control ambit of one or more serving cell equipment. In a similar manner, detection engine 102 can use the facilities and/or functionalities of detection systems that use radio waves to determine the range, angle, or velocity of objects and to determine whether or not UE are approaching and/or entering into the determined vicinity of serving cell equipment.

Other mechanisms used by detection engine 102 to track UE can also include determining UE position based on the measurement of the time of arrival (TOA) of one or more energy wave having known waveforms and/or velocities when propagating either from and/or to multiple emitters and/or receivers of the waves such as one or more network equipment (e.g., serving cell equipment, base station equipment, IoT equipment, picocell equipment, femtocell equipment, and similarly functional equipment). In some instances, a UE's returned signal strength values to various antennae associated with the one or mode network equipment (e.g., network equipment 100, serving cell equipment, base station equipment, IoT equipment, picocell equipment, femtocell equipment, and similarly functional equipment, . . . ) can be used to triangulate and provide positional references as to the trajectory of an individual UE.

Detection engine 102 based on determining that UE is approaching a monitoring ambit of serving equipment can initiate processes to facilitate and/or effectuate the following tasks: (i) based on report data that can have been received, for example, from the approaching UE, a determination can be made as to whether or not the approaching UE is a terrestrial based UE or an aerial UE (e.g. UAV). This determination can be made based, for instance, on IMSI values, SIM values, and/or flag data representative of whether or not the UE is an terrestrial based UE or an airborne vehicle (UAV); (ii) in response to determining that the UE is actually an UAV, instruction can be directed to serving cell equipment (e.g., to which the UAV is attaching to, and/or to which the UAV is already attached to, to power up first groups of beams that can be associated with a collection of up tilted antenna arrays that can be affiliated with the serving cell equipment; (iii) also in response to determining that the UE is actually an UAV, additional instructions can be directed to neighboring serving cell equipment (e.g., to which control and/or service for the UAV, in the future, can be HO to, to power up second groups of beams that can be associated with a aggregation of up tilted antenna arrays that can be affiliated with the neighboring serving cell equipment; (iv) the UAV can be tracked, controlled, monitored, and/or serviced by the first groups of beams associated with the serving cell equipment, wherein tracking of the UAV can be facilitated by observation of beams of the first groups of beams with which the UAV has attached to and has interactions with (e.g., the beams of the first groups of beams that the serving cell equipment uses to interact with, control and/or service the UAV); (v) based, at least in part, on the beams of the first groups of beams with which the UAV has had, or is currently having, with the serving cell equipment, inferences can be made as one or more possible trajectory that the UAV can follow in a defined future time period (e.g., 5 nanoseconds, 10 microseconds, 10 seconds, 15 seconds, 45 seconds, 1 minute, 3 minutes, 5 minutes, . . . ), identification and/or determination of possible future trajectories that the UAV can take can be determined using artificial intelligence methodologies, cost benefit analyses, multi-objective optimization, neural network mechanisms, processes that implement fuzzy logic, and/or similar mechanisms; (vi) based at least in part on the inferences in regard to likely future trajectory that the UAV can take into a future projected time horizon (e.g., 5 nanoseconds, 10 microseconds, 10 seconds, 15 seconds, 45 seconds, 1 minute, 3 minutes, 5 minutes, . . . ), instructions can be sent to neighboring serving cell equipment, that fall within the flight path(s) of the predicted and/or projected future trajectories associated with the UAV, that these identified neighboring serving cell equipment should power up their upward facing beam groupings and commence emitting groups of beams; (vii) based on tracking and/or monitoring the UAV, a determination can be made that the UAV is no longer associated with any of the groups of beams that are being emitted by the serving cell equipment—responsibility for monitoring, tracking, controlling, and/or serving the UAV has evidently been handed over to one or more neighboring serving cell equipment; and (viii) in response to determining that the UAV has departed the control ambit of the serving cell equipment, instructions can be directed to the serving cell equipment that it should now power down the first group beams, wherein the first group of beams are pointing up and are generally being emitted by collections of antenna arrays that are up tilted.

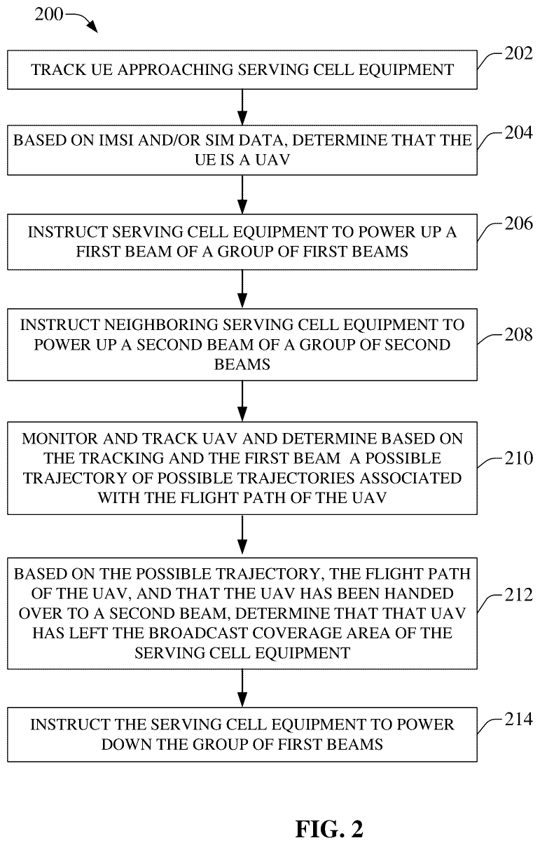

In view of the example system(s) described above, example method(s) that can be implemented in accordance with the disclosed subject matter can be better appreciated with reference to the flowcharts and/or illustrative time sequence charts in FIGS. 2-7. For purposes of simplicity of explanation, a example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 2 illustrates a flow chart, time sequence chart, or method 200 that can be used to effectuate efficient beam sweeping when servicing aerial UE or UAVs over advanced network equipment. Method 200 can be used by central node global control equipment located on the core network. Examples of central node global control equipment can be MEC equipment, SON equipment, and/or RIC equipment.

Method 200 can commence at act 202 wherein central node global equipment (e.g., detection engine 102) can track, monitor, and identify UE, and in particular aerial UE, based at least in part, for example, on IMSI values, or SIM values. Additionally and/or alternatively, at act 202, detection engine 102 can identify approaching UE based on other subscriber or subscription data, such as unique UE serial number values, governmentally issued unique identification values, such as federal aviation administration tag values, UE manufacturer serial number values, UE model number values, unique visual identification values affixed to UE, unique identification values rendered perceivable using, for example, irradiated ultra-violet light, and/or unique identification values rendered observable, for instance, through illumination using infra-red light.

In response to determining that UE is approaching a monitoring ambit of serving equipment detection engine 102 based on report data that can have been received, for example, from the approaching UE, can at act 204 determine whether or not the approaching UE is a terrestrial based UE or an aerial UE (e.g. UAV). This determination can be made based, for instance, on IMSI values, SIM values, and/or flag data representative of whether or not the UE is an terrestrial based UE or an airborne vehicle (UAV).

At act 206, in response to determining that the UE is actually an UAV, instruction can be directed to serving cell equipment (e.g., to which the UAV is attaching to, and/or to which the UAV is already attached to, to power up first groups of beams that can be associated with a collection of up tilted antenna arrays that can be affiliated with the serving cell equipment. At act 208, also in response to determining that the UE is actually an UAV, additional instructions can be directed to neighboring serving cell equipment (e.g., to which control and/or service for the UAV, in the future, can be HO to, to power up second groups of beams that can be associated with a aggregation of up tilted antenna arrays that can be affiliated with the neighboring serving cell equipment.

At act 210 the UAV can be tracked, controlled, monitored, and/or serviced by the first groups of beams associated with the serving cell equipment, wherein tracking of the UAV can be facilitated by observation of beams of the first groups of beams with which the UAV has attached to and has interactions with (e.g., the beams of the first groups of beams that the serving cell equipment uses to interact with, control and/or service the UAV). Also at act 210, based, at least in part, on the beams of the first groups of beams with which the UAV has had, or is currently having, with the serving cell equipment, inferences (determinations) can be made as one or more possible trajectory that the UAV can follow in a defined future time period. At act 212, based at least in part on the inferences (determinations) in regard to likely future trajectory that the UAV can take into a future projected time horizon, instructions can be sent to neighboring serving cell equipment, that fall within the flight path(s) of the predicted and/or projected future trajectories associated with the UAV, that these identified neighboring serving cell equipment should power up their upward facing beam groupings and commence emitting groups of beams. Also at act 212 based on tracking and/or monitoring data associated with the UAV, a determination can be made that the UAV is no longer associated with any of the groups of beams that are being emitted by the serving cell equipment (e.g., responsibility for monitoring, tracking, controlling, and/or serving the UAV has evidently been handed over to one or more neighboring serving cell equipment). At act 214, in response to determining that the UAV has departed the control ambit of the serving cell equipment, instructions can be directed to the serving cell equipment that it should now power down the first group beams, wherein the first group of beams are pointing up and are generally being emitted by collections of antenna arrays that are up tilted.

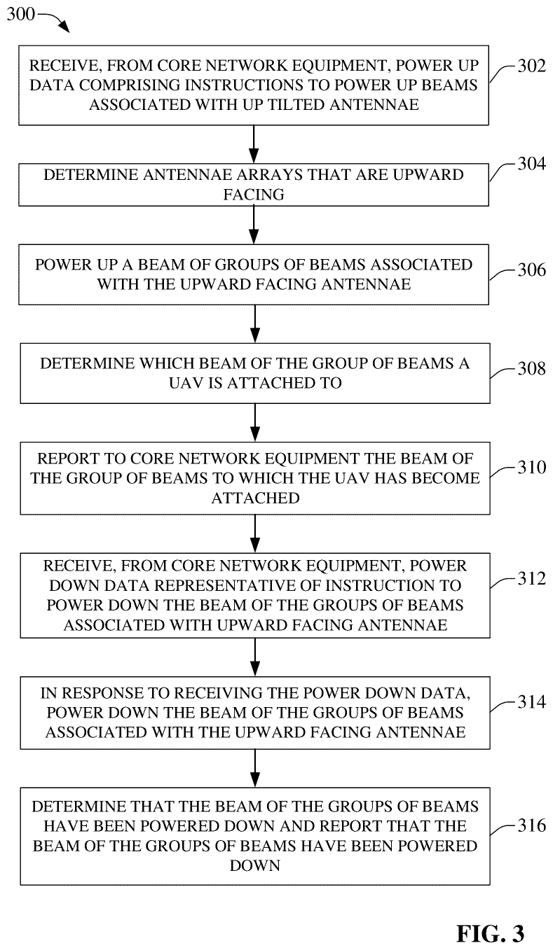

FIG. 3 illustrates a flow chart, time sequence chart, or method 300 that can be used to effectuate efficient beam sweeping when servicing aerial UE or UAVs over advanced network equipment. Method 300 can be implemented on serving cell equipment. Method 300 can commence at act 302 whereupon serving cell equipment can receive, via core network equipment, power up data comprising instructions to power up beams associated with up tilted antennae. At act 304, a determination can be made in regard to antennae arrays that are upward facing. At 306, a beam of groups of beams associated with up tilted antennae can be powered up. At 308 a determination can be made as to which beam of the group of beams that a UAV has attached to. At 310 serving cell equipment can report to core network equipment the beam of the group of beams to which the UAV has become attached. At 312 serving cell equipment can receive, via core network equipment, power down data representative of instructions to power down the beam of the group of beams associated with the upward facing antennae. At 314 serving cell equipment, in response to receiving power down data, can power down the beam of the group of beams associated with the upward facing antennae. At 316 a determination can be made as to whether or not the beam of the group of beams has actually powered down, and the fact that the beam of the group of beams has been powered down can be reported back to the core network equipment.

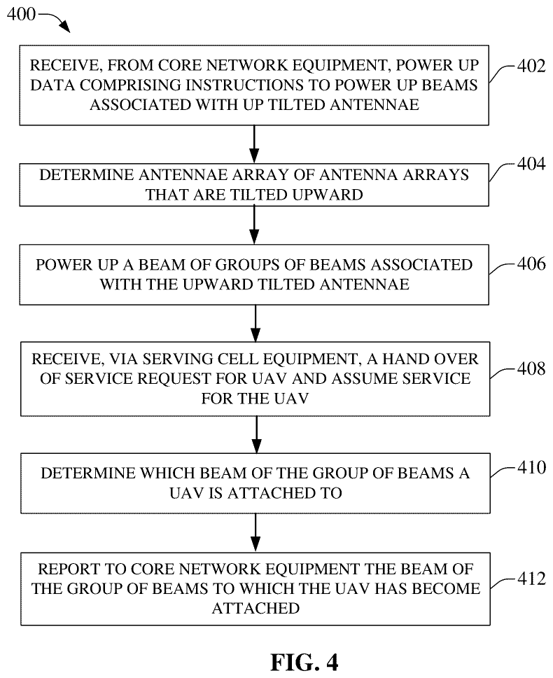

FIG. 4 illustrates a flow chart, time sequence chart, or method 400 that can be used to effectuate efficient beam sweeping when servicing aerial UE or UAVs over advanced network equipment. Method 400 can be implemented by neighboring serving cell equipment. Method 400 can begin at act 402 wherein neighboring serving cell equipment can receive, via core network equipment, power up data comprising instructions to power up beams associated with up tilted antennae. At 404 neighboring serving cell equipment can determine which antenna array of antenna arrays that are up tilted. At 406 neighboring serving cell equipment can power up a beam of the group of beams associated with the up tilted antennae. At 408 neighboring serving cell equipment, via serving cell equipment, can receive hand over of service data requesting that service for a UAV be taken over by neighboring serving cell equipment, and thereafter neighboring serving cell equipment can undertake service for the UAV. At act 410 neighboring serving cell equipment can determine which beam of the group of beams a UAV is attached to, and at act 412 neighboring serving cell equipment can report to core network equipment the beam of the group of beams to which the UAV has become attached.

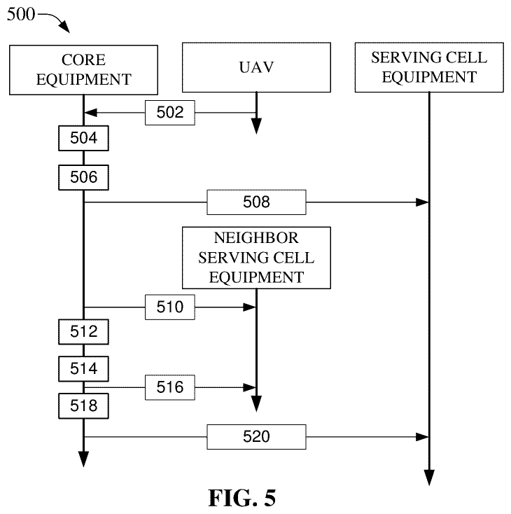

FIG. 5 illustrates a flow chart, time sequence chart, or method 500 that can be used to effectuate efficient beam sweeping when servicing aerial UE or UAVs over advanced network equipment, in accordance with disclosed aspects. Method 500 can commence at act 502 wherein report data comprising IMSI values, SIM values, and/or flag data representative of whether or not the UE is an terrestrial based UE or an airborne vehicle (UAV) can be received by core equipment. At act 504 core equipment can track, monitor, and identify UE, and in particular aerial UE, based at least in part, for example, on the IMSI values, or SIM values reported to it from UAVs. In response to determining that UE is approaching a monitoring ambit of serving cell equipment core network equipment, based on report data that can have been received at act 502 from the approaching UE, can at act 506 determine whether or not the approaching UE is a terrestrial based UE or an aerial UE (e.g. UAV).

At act 508, in response to determining that the UE is actually an UAV, instruction can be directed to serving cell equipment to power up first groups of beams that can be associated with a collection of up tilted antenna arrays that can be affiliated with the serving cell equipment. At act 510, also in response to determining that the UE is actually an UAV, additional instructions can be directed to neighboring serving cell equipment to power up second groups of beams that can be associated with a aggregation of up tilted antenna arrays that can be affiliated with the neighboring serving cell equipment.

At act 512 the UAV can be tracked, controlled, monitored, and/or serviced by the first groups of beams associated with the serving cell equipment, wherein tracking of the UAV can be facilitated by observation of beams of the first groups of beams with which the UAV has attached to and has interactions with. Also at act 514, based, at least in part, on the beams of the first groups of beams with which the UAV has had, or is currently having, with the serving cell equipment, inferences (determinations) can be made as one or more possible trajectory that the UAV can follow in a defined future time period. At act 516, based at least in part on the inferences (determinations) in regard to likely future trajectory that the UAV can take into a future projected time horizon, instructions can be sent to neighboring serving cell equipment, that fall within the flight path(s) of the predicted and/or projected future trajectories associated with the UAV, that these identified neighboring serving cell equipment should power up their upward facing beam groupings and commence emitting groups of beams. At act 518 based on tracking and/or monitoring data associated with the UAV, a determination can be made that the UAV is no longer associated with any of the groups of beams that are being emitted by the serving cell equipment (e.g., responsibility for monitoring, tracking, controlling, and/or serving the UAV has evidently been handed over to one or more neighboring serving cell equipment). At act 520, in response to determining that the UAV has departed the control ambit of the serving cell equipment, instructions can be directed to the serving cell equipment that it should now power down the first group beams, wherein the first group of beams are pointing up and are generally being emitted by collections of antenna arrays that are up tilted.

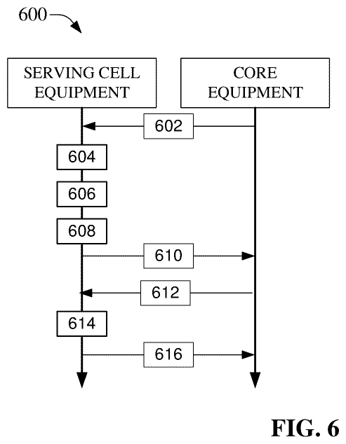

FIG. 6 illustrates a flow chart, time sequence chart, or method 600 that can be used to effectuate efficient beam sweeping when servicing aerial UE or UAVs over advanced network equipment, in accordance with disclosed aspects. Time sequence chart 600 can commence at act 602 where serving cell equipment can receive, from core equipment, instruction data representing instructions to power up first groups of beams that can be associated with a collection of up tilted antenna arrays that can be affiliated with the serving cell equipment. At act 604 serving cell equipment can determine which of a grouping of antennae are upward facing (e.g., tilted upward). At act 606 serving cell equipment can power up a beam of a group of beams associated with the grouping of up tilted antennae. At 608 serving cell equipment can determine which beam of the group of beams that a UAV has attached to, and to which serving cell equipment is providing service. At act 610 serving cell equipment can send a report to core equipment regarding the beam of the group of beams to which the UAV has become attached, and through which service is being provided to the UAV. At act 612, in response to the UAV having departed the service ambit of serving cell equipment (e.g., service for the UAV has been handed over to neighboring serving cell equipment), core equipment can send power down instructions to the serving cell equipment that it should power down the beam of a group of beams associated with the grouping of up tilted antennae. At acts 614 and 616 serving cell equipment in response to the power down instructions received from core equipment can respectively power down the beam of the group of beams associated with the grouping of up tilted antennae, and then send confirmation to core equipment that the beam of the a group of beams associated with the grouping of up tilted antennae has been powered down.

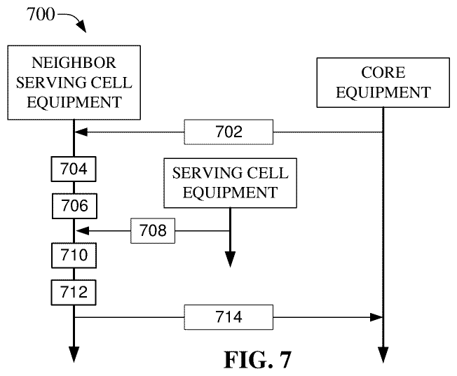

FIG. 7 illustrates a flow chart, time sequence chart, or method 700 that can be used to effectuate efficient beam sweeping when servicing aerial UE or UAVs over advanced network equipment, in accordance with disclosed aspects. Time sequence chart 700 can commence at act 702 where neighboring serving cell equipment can receive, from core equipment, instruction data representing instructions to power up first groups of beams that can be associated with a collection of up tilted antenna arrays that can be affiliated with the serving cell equipment. At act 704 neighboring serving cell equipment can determine which of a grouping of antennae are upward facing (e.g., tilted upward). At act 706 neighboring serving cell equipment can power up a beam of a group of beams associated with the grouping of up tilted antennae. At 708 neighboring serving cell equipment can receive a handover request from serving cell equipment for the neighboring serving cell equipment to provided service for a UAV. At 710 neighboring serving cell equipment can takeover servicing the UAV from the serving cell equipment. At act 712 neighboring cell equipment can identify the beam of the group of beams that the UAV has attached to, and act 714, neighboring cell equipment can report the beam of the group of beams to which the UAV has attached to core equipment.

In regard to the foregoing disclosure, it should be noted that central node global control equipment can collect key performance indicator (KPI) values returned to, or received by, serving cell equipment (or central node global control equipment) by UE (terrestrial based and/or aerial) located within the coverage ambit of serving cell equipment. Examples of KPI values that can be returned by UE to serving cell equipment can include: values associated with RSRP measurement values, received signal strength indicator (RSSI) measurement values, quality of service (QoS) metric values, signal to noise ratio (SNR) values, received signal code power (RSCP) values, signal to interference ratio (SIR) values, signal to interference plus noise ratio (SINR) values, distance measurement values (e.g., determined based on global positioning satellite (GPS) data, geo-location data, geo-tag data, or other such relevant positioning data) indicating distances between UE and serving cell equipment, distance measurement values indicating distances between UE and respective neighboring serving cell equipment, or other similarly appropriate values. As has been noted, KPI values can be values that can have been periodically returned within measurement reports by UE extant within the control and/or coverage ambit associated with network equipment, such as serving cell equipment, neighboring serving cell equipment, or similar network equipment.

Many use cases of unmanned aerial vehicles (UAVs), such as drones, require beyond visual line of sight (LOS) communications. Mobile networks can offer wide area, high speed, and secure wireless connectivity, which can enhance control and safety of UAV operations and enable beyond visual LOS use cases. Existing long term evolution (LTE) networks can support initial drone deployments. LTE evolution and 5G can provide more efficient connectivity for wide-scale drone deployments. New and exciting applications for drones are being envisioned and are emerging. These envisioned and prospective applications can be a potential boon for mobile network operator entities. Use cases of commercial UAVs are growing rapidly, including delivery, communications and media, inspection of critical infrastructure, surveillance, search-and-rescue operations, agriculture, and similar worthy endeavors.

Research and development of current mobile broadband communication (e.g., LTE) has been primarily devoted to terrestrial based communication. Providing tether-less broadband connectivity for UAVs is an emerging field.

One main aspect that makes using LTE to serve UAVs challenging is the fact that mobile LTE networks are generally optimized for terrestrial broadband communication. Thus, the antennas associated with terrestrial based serving equipment (such as base station equipment, eNodeB equipment, eNB equipment, gNodeB equipment, picocell equipment, macrocell equipment, microcell equipment, femtocell equipment, IoT equipment operating as mobile network operation (MNO) network equipment, access point equipment, and the like) are typically down-tilted to reduce the interference power levels to other serving cell equipment. With down tilted antennas, small UAVs may thus only be served by transmission or broadcast side lobes of the antennas associated with terrestrial based serving cell equipment.

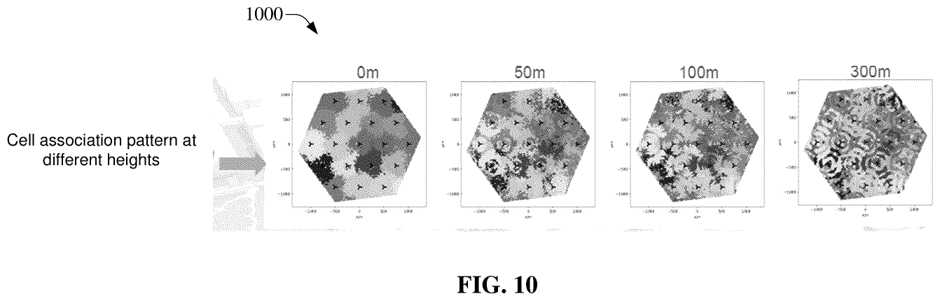

FIG. 10 provides depiction of the relative disparities in coverage areas between terrestrial coverage areas and aerial coverage areas. In FIG. 10 it will be observed, that at lesser heights, for example, at 0 meters (m) the broadcast coverage area pattern of network cell equipment is generally distinct and clear; the coverage areas being defined clusters around one or more central point associated with respective network cell equipment. However, at greater heights (e.g., 50 m, 100 m, 300 m) above terrain the coverage areas associated with respective network equipment become less and less well defined and more and more amorphous.

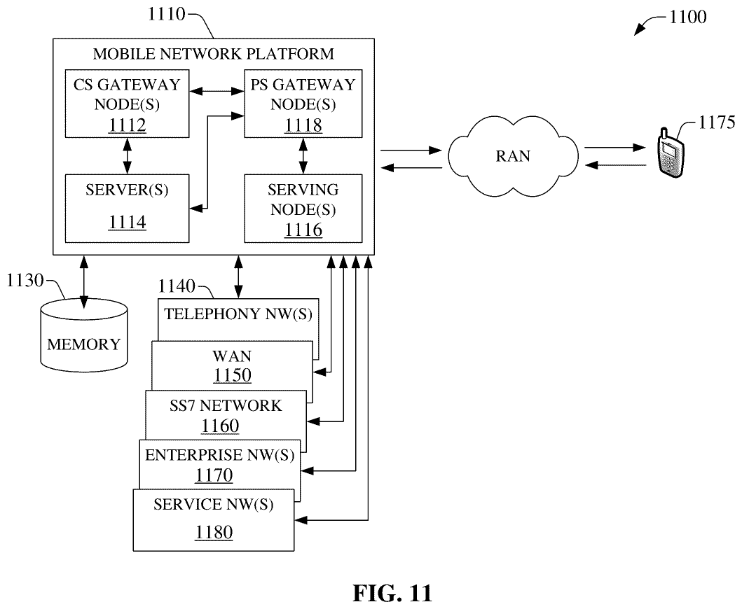

FIG. 11 presents an example embodiment 1100 of a mobile network platform 1110 that can implement and exploit one or more aspects of the disclosed subject matter described herein. Generally, wireless network platform 1110 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 1110 can be included in telecommunications carrier networks, and can be considered carrier-side components as discussed elsewhere herein. Mobile network platform 1110 includes CS gateway node(s) 1112 which can interface CS traffic received from legacy networks like telephony network(s) 1140 (e.g., public switched telephone network (PSTN), or public land mobile network (PLMN)) or a signaling system #7 (SS7) network 1170. Circuit switched gateway node(s) 1112 can authorize and authenticate traffic (e.g., voice) arising from such networks. Additionally, CS gateway node(s) 1112 can access mobility, or roaming, data generated through SS7 network 1160; for instance, mobility data stored in a visited location register (VLR), which can reside in memory 1130. Moreover, CS gateway node(s) 1112 interfaces CS-based traffic and signaling and PS gateway node(s) 1118. As an example, in a 3GPP UMTS network, CS gateway node(s) 1112 can be realized at least in part in gateway GPRS support node(s) (GGSN). It should be appreciated that functionality and specific operation of CS gateway node(s) 1112, PS gateway node(s) 1118, and serving node(s) 1116, is provided and dictated by radio technology(ies) utilized by mobile network platform 1110 for telecommunication.

In addition to receiving and processing CS-switched traffic and signaling, PS gateway node(s) 1118 can authorize and authenticate PS-based data sessions with served mobile devices. Data sessions can include traffic, or content(s), exchanged with networks external to the wireless network platform 1110, like wide area network(s) (WANs) 1150, enterprise network(s) 1170, and service network(s) 1180, which can be embodied in local area network(s) (LANs), can also be interfaced with mobile network platform 1110 through PS gateway node(s) 1118. It is to be noted that WANs 1150 and enterprise network(s) 1170 can embody, at least in part, a service network(s) like IP multimedia subsystem (IMS). Based on radio technology layer(s) available in technology resource(s) 1117, packet-switched gateway node(s) 1118 can generate packet data protocol contexts when a data session is established; other data structures that facilitate routing of packetized data also can be generated. To that end, in an aspect, PS gateway node(s) 1118 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1100, wireless network platform 1110 also includes serving node(s) 1116 that, based upon available radio technology layer(s) within technology resource(s) 1117, convey the various packetized flows of data streams received through PS gateway node(s) 1118. It is to be noted that for technology resource(s) 1117 that rely primarily on CS communication, server node(s) can deliver traffic without reliance on PS gateway node(s) 1118; for example, server node(s) can embody at least in part a mobile switching center. As an example, in a 3GPP UMTS network, serving node(s) 1116 can be embodied in serving GPRS support node(s) (SGSN).

For radio technologies that exploit packetized communication, server(s) 1114 in wireless network platform 1110 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1110. Data streams (e.g., content(s) that are part of a voice call or data session) can be conveyed to PS gateway node(s) 1118 for authorization/authentication and initiation of a data session, and to serving node(s) 1116 for communication thereafter. In addition to application server, server(s) 1114 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1110 to ensure network's operation and data integrity in addition to authorization and authentication procedures that CS gateway node(s) 1112 and PS gateway node(s) 1118 can enact. Moreover, provisioning server(s) can provision services from external network(s) like networks operated by a disparate service provider; for instance, WAN 1150 or Global Positioning System (GPS) network(s) (not shown). Provisioning server(s) can also provision coverage through networks associated to wireless network platform 1110 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 1175.

It is to be noted that server(s) 1114 can include one or more processors configured to confer at least in part the functionality of macro network platform 1110. To that end, the one or more processor can execute code instructions stored in memory 1130, for example. It is should be appreciated that server(s) 1114 can include a content manager 1115, which operates in substantially the same manner as described hereinbefore.

In example embodiment 1100, memory 1130 can store information related to operation of wireless network platform 1110. Other operational information can include provisioning information of mobile devices served through wireless platform network 1110, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1130 can also store information from at least one of telephony network(s) 1140, WAN 1150, enterprise network(s) 1170, or SS7 network 1160. In an aspect, memory 1130 can be, for example, accessed as part of a data store component or as a remotely connected memory store.

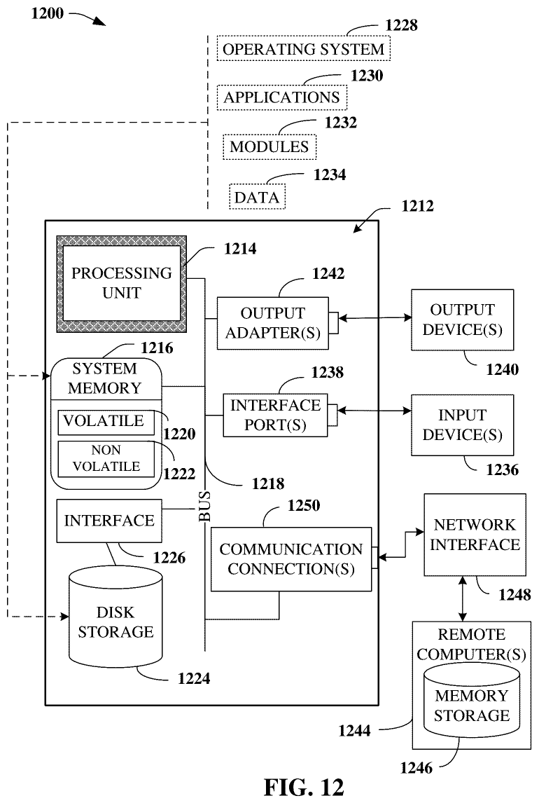

In order to provide a context for the various aspects of the disclosed subject matter, FIG. 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1220 (see below), non-volatile memory 1222 (see below), disk storage 1224 (see below), and memory storage 1246 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 12 illustrates a block diagram of a computing system 1200 operable to execute one or more parts of one or more of the disclosed example embodiments. Computer 1212, which can be, for example, part of the hardware of system 100, includes a processing unit 1214, a system memory 1216, and a system bus 1218. System bus 1218 couples system components including, but not limited to, system memory 1216 to processing unit 1214. Processing unit 1214 can be any of various available processors. Dual microprocessors and other multiprocessor architectures also can be employed as processing unit 1214.

System bus 1218 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect, Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

System memory 1216 can include volatile memory 1220 and nonvolatile memory 1222. A basic input/output system (BIOS), containing routines to transfer information between elements within computer 1212, such as during start-up, can be stored in nonvolatile memory 1222. By way of illustration, and not limitation, nonvolatile memory 1222 can include ROM, PROM, EPROM, EEPROM, or flash memory. Volatile memory 1220 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 can also include removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to system bus 1218, a removable or non-removable interface is typically used, such as interface 1226.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 12 describes software that acts as an intermediary between users and computer resources described in suitable operating environment 1200. Such software includes an operating system 1228. Operating system 1228, which can be stored on disk storage 1224, acts to control and allocate resources of computer system 1212. System applications 1230 take advantage of the management of resources by operating system 1228 through program modules 1232 and program data 1234 stored either in system memory 1216 or on disk storage 1224. It is to be noted that the disclosed subject matter can be implemented with various operating systems or combinations of operating systems.

A user can enter commands or information into computer 1212 through input device(s) 1236. As an example, mobile device and/or portable device can include a user interface embodied in a touch sensitive display panel allowing a user to interact with computer 1212. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1214 through system bus 1218 by way of interface port(s) 1238. Interface port(s) 1238 include, for example, a serial port, a parallel port, a game port, a universal serial bus (USB), an infrared port, a Bluetooth port, an IP port, or a logical port associated with a wireless service, etc. Output device(s) 1240 use some of the same type of ports as input device(s) 1236.

Thus, for example, a USB port can be used to provide input to computer 1212 and to output information from computer 1212 to an output device 1240. Output adapter 1242 is provided to illustrate that there are some output devices 1240 like monitors, speakers, and printers, among other output devices 1240, which use special adapters. Output adapters 1242 include, by way of illustration and not limitation, video and sound cards that provide means of connection between output device 1240 and system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. Remote computer(s) 1244 can be a personal computer, a server, a router, a network PC, cloud storage, cloud service, a workstation, a microprocessor based appliance, a peer device, or other common network node and the like, and typically includes many or all of the elements described relative to computer 1212.

For purposes of brevity, only a memory storage device 1246 is illustrated with remote computer(s) 1244. Remote computer(s) 1244 is logically connected to computer 1212 through a network interface 1248 and then physically connected by way of communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1250 refer(s) to hardware/software employed to connect network interface 1248 to bus 1218. While communication connection 1250 is shown for illustrative clarity inside computer 1212, it can also be external to computer 1212. The hardware/software for connection to network interface 1248 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) LTE; 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of embodiments illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system comprising:
a processor; and
a memory that stores instructions that, when executed by the processor, facilitates performance of operations, comprising:
based on user equipment data associated with a user equipment and tracking data associated with the user equipment, determining that the user equipment is an unmanned aerial vehicle;
instructing serving cell equipment to power up a first beam of a first group of beams;
instructing neighbor serving cell equipment, neighboring the serving cell equipment, to power a second beam of a second group of beams;
determining, based on the tracking data and the first beam to which the unmanned aerial vehicle is attached, a trajectory of trajectories associated with a flight path of the unmanned aerial vehicle;
based on the trajectory, the flight path, and handover event data representing a handover of the unmanned aerial vehicle from the serving cell equipment to the neighbor serving cell equipment, determining that the neighbor serving cell equipment is servicing the unmanned aerial vehicle; and
instructing the serving cell equipment to power down the first beam of the first group of beams.

2. The system of claim 1, wherein the operations further comprising determining the first group of beams based on a group of antenna arrays that are pointing upward, or substantially upward.

3. The system of claim 1, wherein the operations further comprising determining the second group of beams based on a group of antenna arrays that are pointing upward, or substantially upward.

4. The system of claim 1, wherein the user equipment data comprises flag data that represents that the unmanned aerial vehicle is capable of flight.

5. The system of claim 1, wherein the first beam of the first group of beams corresponding to the serving cell equipment is powered down based on an absence of the unmanned aerial vehicle to preserve energy, and the first beam of the first group of beams is powered up based on detecting that the unmanned aerial vehicle has entered, or is entering, a coverage region of the serving cell equipment, wherein the first group of beams are powered up to enable communication between the serving cell equipment and the unmanned aerial vehicle.

6. The system of claim 1, wherein the second beam of the second group of beams corresponding to the neighboring serving cell equipment is powered down based on an absence of the unmanned aerial vehicle to preserve energy, and the second beam of the second group of beams is powered up based on detecting that the unmanned aerial vehicle has entered, or is entering, a coverage region of the neighboring serving cell equipment, wherein the second group of beams are powered up to enable communication between the neighboring serving cell equipment and the unmanned aerial vehicle.

7. The system of claim 1, wherein the operations further comprise tracking the unmanned aerial vehicle through a broadcast coverage area projected by the serving cell equipment based on determining a time or arrival of an energy wave having a defined velocity propagated among the serving cell equipment.

8. The system of claim 1, wherein the operations further comprise determining the trajectory of trajectories based on a multi-objective process representing a determination that a group of first actions is to be implemented in response to a group of second actions, on a threshold balance of probabilities, being determined not to be detrimentally affected by the group of first actions.

9. A method, comprising:
based on user equipment data associated with a user equipment and tracking data associated with the user equipment, determining, by a device comprising a processor, that the user equipment is an unmanned aerial vehicle;
instructing, by the device, serving cell equipment to power up a first beam of a first group of beams;
instructing, by the device, neighbor serving cell equipment, determined to be within a defined distance of the serving cell equipment, to power a second beam of a second group of beams;
based on the tracking data and the first beam to which the unmanned aerial vehicle is attached, determining, by the device, a trajectory of trajectories associated with a flight path of the unmanned aerial vehicle;
based on the trajectory, the flight path, and handover event data representing a transfer of network service of the unmanned aerial vehicle from the serving cell equipment to the neighbor serving cell equipment, determining, by the device, that the neighbor serving cell equipment is servicing the unmanned aerial vehicle; and
instructing, by the device, the serving cell equipment to power down the first beam of the first group of beams.

10. The method of claim 9, further comprising determining, by the device, the first group of beams based on a group of antenna arrays that are determined to be pointing upward.

11. The method of claim 9, further comprising determining, by the device, the second group of beams based on a group of antenna arrays that are determined to be pointing upward.

12. The method of claim 9, wherein the user equipment data comprises flag data that represents that the unmanned aerial vehicle is capable of flight.

13. The system of claim 9, wherein the first beam of the first group of beams associated with the serving cell equipment is powered down in response to detecting an absence of the unmanned aerial vehicle to conserve energy, and the first beam of the first group of beams is powered up in response to detecting that the unmanned aerial vehicle has entered a coverage area of the serving cell equipment, or is entering the coverage area of the serving cell equipment, wherein the first beam is powered up to enable communication between the serving cell equipment and the unmanned aerial vehicle.

14. The system of claim 9, wherein the second beam of the second group of beams associated with the neighboring serving cell equipment is powered down in response to detecting an absence of unmanned aerial vehicle to conserve energy, and the second beam of the second group of beams is powered up in response to detecting that the unmanned aerial vehicle has entered, or is entering, a coverage area of the neighboring cell to enable communication between the neighboring serving cell equipment and the unmanned aerial vehicle.

15. The method of claim 9, further comprising determining, by the device, the trajectory of trajectories based on determining that a group of first actions, to be implemented in response to a group of second actions, on a balance of probabilities, is not going to detrimentally affect the group of second actions.

16. A non-transitory machine-readable medium, comprising executable instructions that, when executed by a processor, facilitate performance of operations, comprising:
based on user equipment data and tracking data associated with a user equipment, determining that the user equipment is an unmanned aerial vehicle;
instructing a serving cell to power up a first beam of a first group of beams;
instructing neighbor serving cell to power up a second beam of a second group of beams;
based on the tracking data and the first beam to which the unmanned aerial vehicle is attached, determining a trajectory of trajectories associated with a flight path of the unmanned aerial vehicle;
based on the trajectory, the flight path, and handover event data representing a handover of the unmanned aerial vehicle from the serving cell to the neighbor serving cell, determining that the neighbor serving cell is servicing the unmanned aerial vehicle; and
instructing the serving cell to power down the first beam of the first group of beams.

17. The non-transitory machine-readable medium of claim 16, the operations further comprising monitoring the unmanned aerial vehicle through a broadcast coverage area projected by the serving cell based on determining a time or arrival of an energy wave having a defined waveform propagated among the serving cell.

18. The non-transitory machine-readable medium of claim 16, the operations further comprising tracking the unmanned aerial vehicle through a broadcast coverage area projected by the serving cell based on determining a time or arrival of an energy wave having a defined velocity propagated among the serving cell.

19. The non-transitory machine-readable medium of claim 16, the operations further comprising determining the trajectory of trajectories based on predicting that a group of first actions, to be implemented in response to a group of second actions, on a balance of probabilities, will not detrimentally affect the group of second actions.

20. The non-transitory machine-readable medium of claim 16, the operations further comprising powering up an energy beam of a group of energy beams associated with the serving cell to enable communication between the serving cell and the unmanned aerial vehicle, in response to determining that the unmanned aerial vehicle has entered or is about to enter a coverage area of a grouping of serving cells, and powering down the group of beams in response to determining that the unmanned aerial vehicle is no longer in the coverage area of the group of serving cells to reduce energy consumption.
